(19) United States
(12) Patent Application Publication
(10) Pub. No.: US 2024/0014520 A1
(43) Pub. Date: Jan. 11, 2024

(54) Cylindrical Battery and Battery Module

(71) Applicant: JIANGSU ZENERGY BATTERY TECHNOLOGIES CO., LTD., Jiangsu (CN)

(72) Inventors: Dandan CHEN, Jiangsu (CN); Juntai LU, Jiangsu (CN); Jianliang WEI, Jiangsu (CN); Yehui JIAO, Jiangsu (CN)

(21) Appl. No.: 18/219,021

(22) Filed: Jul. 6, 2023

(30) Foreign Application Priority Data
Jul. 6, 2022 (CN) 202221722367.0

(51) Int. Cl. H01M 50/534; H01M 50/107; H01M 50/152; H01M 50/186; H01M 50/184; H01M 50/213; H01M 50/55

(52) U.S. Cl. CPC H01M 50/534; H01M 50/107; H01M 50/152; H01M 50/186; H01M 50/184; H01M 50/213; H01M 50/55

(57) ABSTRACT

The present disclosure belongs to the technical field of battery production and manufacturing, and specifically relates to a cylindrical battery and a battery module. The cylindrical battery includes: a housing, a cell and a top cover assembly. The housing is provided with an opening. The cell is arranged in the housing, the cell is provided with a first tab and a second tab opposite in polarity to the first tab, and the first tab and the second tab are both located on a same end face of the cell. The top cover assembly seals the opening and includes a cover, a first conductive portion and a second conductive portion. The cover, the first conductive portion and the second conductive portion are in insulating connection, the first conductive portion is connected with the first tab, and the second conductive portion is connected with the second tab.

### CROSS-REFERENCE TO RELATED APPLICATION

The disclosure claims priority to Chinese Patent Application No. 202221722367.0 filed to the China National Intellectual Property Administration on Jul. 6, 2022 and entitled “Cylindrical Battery and Battery Module”, the disclosure of which is hereby incorporated by reference in its entirety.

### TECHNICAL FIELD

The disclosure belongs to the technical field of battery production and manufacturing, and particularly relates to a cylindrical battery and a battery module.

### BACKGROUND

With the development of science and technology, secondary batteries have been widely used in portable electronic devices such as mobile phones, digital cameras and laptop computers, have broad application prospects in large and medium-sized electric devices such as electric automobiles, electric bicycles and other electric vehicles as well as energy storage facilities, and have become an important technical means to solve global problems such as the energy crisis and the environmental pollution. As a new type of secondary battery, a lithium-ion battery has the advantages of high energy density and power density, high working voltage, light weight, small size, long cycle life, good safety, environmental protection, etc., and has broad application prospects in portable electrical appliances, electric tools, large energy storage, electric traffic power supply, etc.

Positive and negative tabs of an existing cylindrical battery respectively extend from both sides thereof in the axial direction, and are connected to corresponding cover plates by a connecting piece. However, such the structure occupies a large internal space of the battery, which affects the utilization rate of internal space of the battery, and accordingly reduces the energy density of the battery.

### Summary

An objective of the disclosure is, in view of the shortcomings of the related art, to provide a cylindrical battery to solve the problems of low the energy density of the battery due to low the utilization rate of an internal space of the battery.

In order to achieve the above objective, the disclosure employs the following technical solutions:
a cylindrical battery, which includes:
a housing, the housing is provided with an opening;
a cell, the cell is arranged in the housing, the cell is provided with a first tab and a second tab opposite in polarity to the first tab, and the first tab and the second tab are both located on a same end face of the cell;
a top cover assembly, the top cover assembly seals the opening and includes a cover, a first conductive portion and a second conductive portion. The cover, the first conductive portion and the second conductive portion are in insulating connection, the first conductive portion is connected with the first tab, and the second conductive portion is connected with the second tab.

In some embodiments, a first through hole and a second through hole are formed in the cover in the thickness direction thereof in a penetrating manner, the first conductive portion is arranged in the first through hole, and is in insulating sealing connection with the cover, and the second conductive portion is arranged in the second through hole, and is in insulating sealing connection with the cover.

In some embodiments, a first insulating seal is arranged between the first through hole and the first conductive portion, and a second insulating seal is arranged between the second through hole and the second conductive portion.

In some embodiments, the cross section of the first insulating seal and/or the cross section of the second insulating seal is T-shaped, [symbol] -shaped or [symbol] -shaped.

In some embodiments, a plurality of first nanopores are formed in a surface where the first through hole is connected to the first insulating seal, and the first insulating seal is in part embedded into the plurality of first nanopores.

And/or, a plurality of second nanopores are formed in a surface where the second through hole is connected to the second insulating seal, and the second insulating seal is in part embedded into the plurality of second nanopores.

In some embodiments, the thickness of the first insulating seal and the thickness of the second insulating seal are both 1-3 mm.

In some embodiments, the first conductive portion is made of a same material as the first tab, and the second conductive portion is made of a same material as the second tab.

In some embodiments, one of the first conductive portion and the second conductive portion is made of aluminum while the other one of the first conductive portion and the second conductive portion is made of copper or nickel-plated copper.

In some embodiments, the cover is made of a same material as the housing.

Another objective of the disclosure is a battery module, including a box and a plurality of batteries. The plurality of batteries are sequentially arranged in the box in the thickness direction of the box, and at least one of the batteries is the cylindrical battery as described above in the specification.

The disclosure is provided with the cylindrical battery. Through the cooperative use of the housing, the cell and the top cover assembly, the cell is arranged in the housing, and the top cover assembly covers the opening of the housing. The cell is provided with the first tab and the second tab, and the first tab and the second tab are located on the same end face of the cell. The top cover assembly includes the cover, the first conductive portion and the second conductive portion. The cover, the first conductive portion and the second conductive portion are in insulating connection, the first conductive portion is connected with the first tab, and the second conductive portion is connected with the second tab. Through the arrangement of the above structure, the disclosure arranges the first tab and the second tab on the same end face of the cell, the first tab is able to be directly connected to the first conductive portion, and the second tab is able to be directly connected to the second conductive portion without the need of a connecting piece, so that the utilization rate of the internal space of the battery may be effectively improved while the cost is saved, and the energy density of the battery is further improved.

### BRIEF DESCRIPTION OF THE DRAWINGS

The features, advantages, and technical effects of exemplary implementations of the present disclosure will be described below with reference to the accompanying drawings.

FIG. 1 is a schematic structural diagram of the present disclosure.

FIG. 2 is a cross-sectional structural diagram of the present disclosure.

FIG. 3 is an enlarged schematic diagram of part A in FIG. 2.

FIG. 4 is another cross-sectional structural diagram of the present disclosure.

FIG. 5 is an enlarged schematic diagram of part B in FIG. 4.

FIG. 6 is a schematic structural diagram of a top cover assembly in the present disclosure.

FIG. 7 is a schematic structural diagram of a cell in the present disclosure.

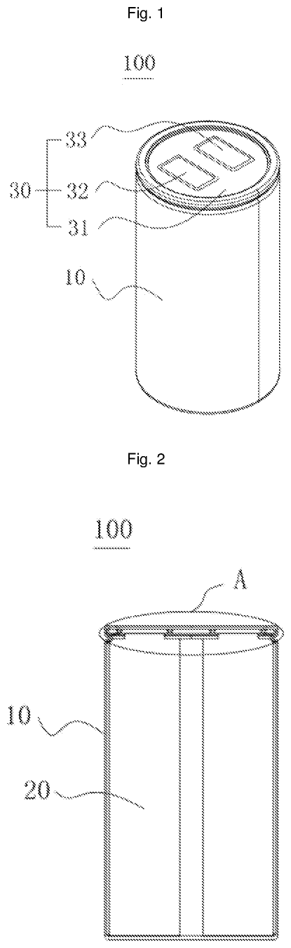

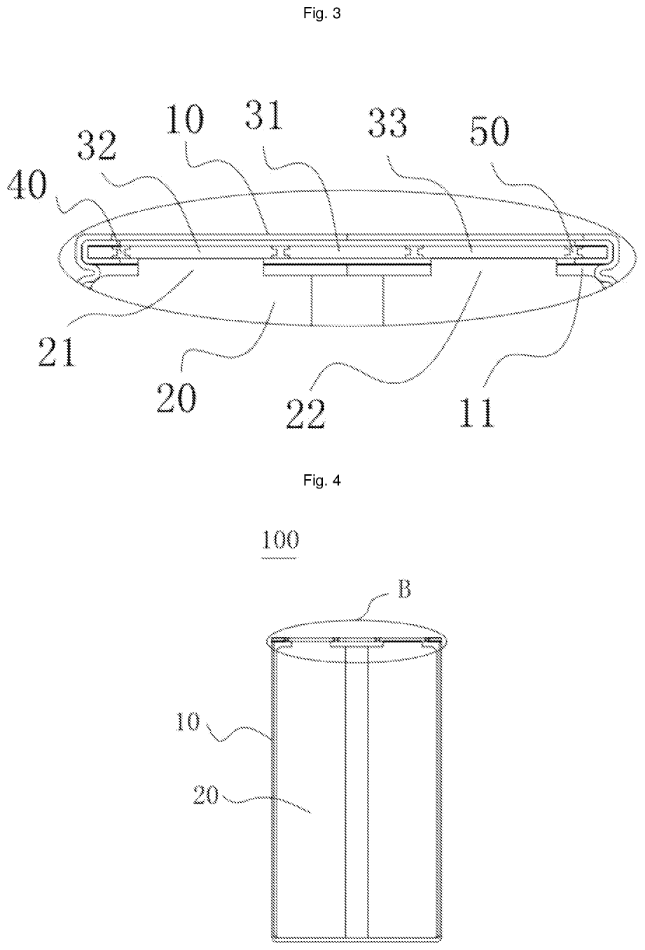

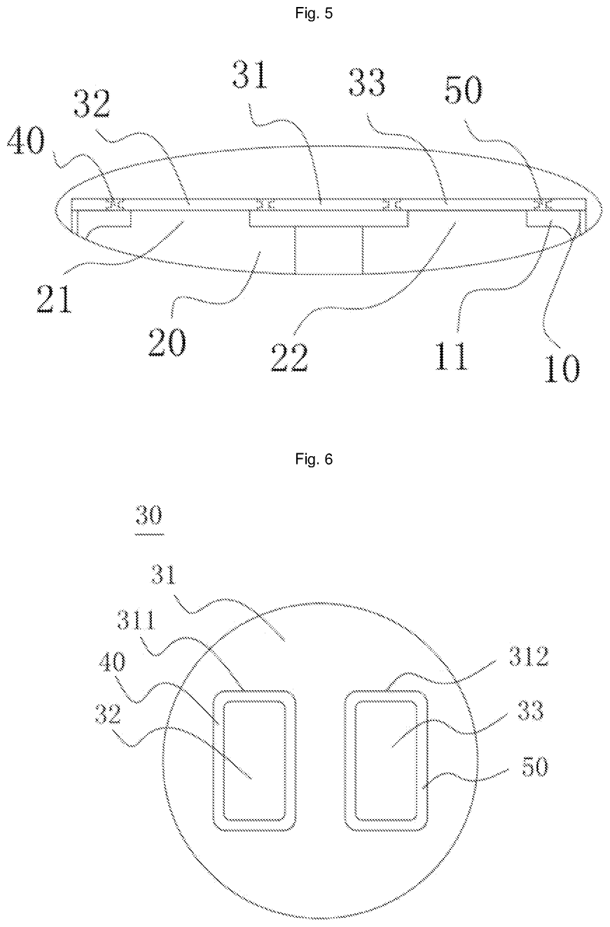

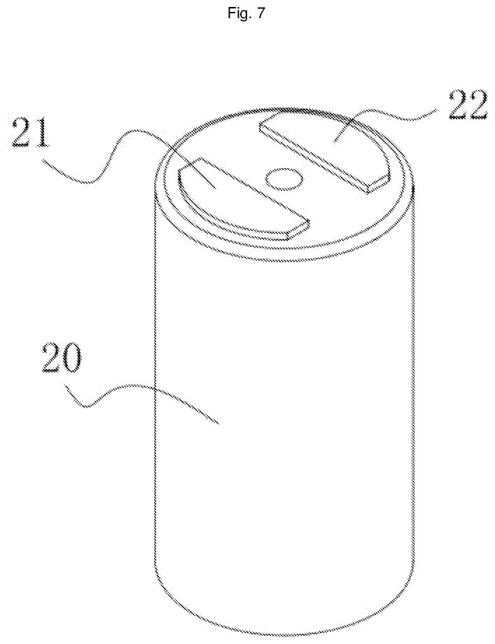

Illustration of the following reference signs:
100. Battery;
10. Housing; 11. Opening;
20. Cell; 21. First tab; 22. Second tab;
30. Top cover assembly; 31. Cover; 311. First through hole; 312. Second through hole; 32. First conductive portion; 33. Second conductive portion;
40. First insulating seal; and
50. Second insulating seal.

### DETAILED DESCRIPTION OF THE EMBODIMENTS

Certain terms are used, for example, in the description and claims to refer to particular components. Those skilled in the art should understand that a hardware manufacturer use different terms to refer to the same component. The specification and claims do not use the difference in name as a way to distinguish components, but use the difference in function of components as a criterion for distinguishing. As mentioned throughout the specification and claims, “comprising” is an open term, so it should be interpreted as “including but not limited to”. “Approximately” means that within an acceptable error range, those skilled in the art may solve technical problems within a certain error range and basically achieve technical effects.

In addition, terms “first” and “second” are only used for describing purposes, and cannot be understood as indicating or implying relative importance.

In the disclosure, unless otherwise clearly specified and limited, the terms “installation”, “mutual connection”, “connection”, “fixation” and other terms shall be understood in a broad sense. For example, the term may be a fixed connection or a detachable connection, or an integrated connection; the term may be a mechanical connection or an electric connection; and the term may be a direct connection or an indirect connection through an intermediary, and may be communication inside two components. Those of ordinary skill in the art may understand the specific meanings of the terms in the present disclosure according to specific conditions.

Reference to an “embodiment” in the present disclosure means that a particular feature, structure or characteristic described in connection with an embodiment may be included in at least one embodiment of the disclosure. The appearance of this phrase “embodiment” in various places in the specification does not necessarily mean the same embodiment, nor is it an independent or alternative embodiment mutually exclusive with other embodiments. Those skilled in the art understand explicitly and implicitly that the embodiments described in the present disclosure may be combined with other embodiments.

In the description of the present disclosure, unless otherwise specified, “a plurality of” means more than two (including two), and similarly, “a plurality of groups” means more than two groups (including two groups).

The present disclosure will be described in further detail below in conjunction with accompanying drawings 1 to 7, but is not limited thereto.

The embodiment of the disclosure is a cylindrical battery, including a housing 10, a cell 20 and a top cover assembly 30. The cell 20 is arranged in the housing 10, the housing 10 is provided with an opening 11, and the top cover assembly 30 seals the opening 11.

In the embodiment of the present disclosure, the housing 10 is provided with an accommodation cavity, and one of the surfaces of the housing 10 is provided with the opening 11. That is, the surface does not have a shell wall so that the inside and outside of the housing 10 communicate with each other, and the cell 20 is accommodated in the accommodation cavity of the housing 10. The top cover assembly 30 covers the housing 10 at the opening 11 to form the hollow cavity. After the cell 20 is loaded into the housing 10 from the opening 11, the opening 11 is sealed by the top cover assembly 30 to prevent a gaseous, liquid or solid substance from circulating between the inside and outside of the housing 10 and affect the performance of the battery 100.

Further, the housing 10 is a hollow cylinder, and at least one end face of the housing 10 is the opening 11. That is, the end face does not have a housing wall so that the inside and outside of the housing 10 communicate with each other. The side wall of the housing 10 is integrally formed with high strength. Or, the housing 10 is made of a metal material or plastic material. In some embodiments, the housing 10 is made of aluminum, aluminum alloy or steel.

The cell 20 in the embodiment of the present disclosure is provided with a first tab 21 and a second tab 22 opposite in polarity to the first tab 21, and the first tab 21 and the second tab 22 are both located on a same end face of the cell 20.

Specifically, in order to prevent the contact between the first tab 21 and the second tab 22 from causing a short circuit of the cell 20, a separator is arranged between the first tab 21 and the second tab 22.

The cell 20 is formed by laminating or winding a first electrode plate, a second electrode plate, and a separator between the first electrode plate and the second electrode plate. Herein, the separator is an insulator between the first electrode plate and the second electrode plate. In addition, an uncoated area extending from a coated area of the first electrode plate is used as the first tab 21, and an uncoated area extending from a coated area of the second electrode plate is used as the second tab 22.

Specifically, the first tab 21 is arranged on the first electrode plate by a die-cutting or a welding. Likewise, the second tab 22 also is arranged on the second electrode plate by the die-cutting or the welding.

Exemplarily, the first electrode plate is a positive electrode plate, and the second electrode plate is a negative electrode plate. Or the first electrode plate is a negative electrode plate, and the second electrode plate is a positive electrode plate. In addition, the positive electrode plate includes a positive current collector and a positive active material layer, and the positive active material layer is coated on the surface of the positive current collector. The positive current collector includes a positive current collecting portion and a positive protrusion protruding from the positive current collecting portion. The positive current collecting portion is coated with the positive active material layer, at least a portion of the positive protrusion is not coated with the positive active material layer, and the positive protrusion serves as a positive tab. Taking a lithium-ion battery 100 as an example, the material of the positive current collector is aluminum. The positive active material layer includes a positive active material, and the positive active material is lithium cobaltate, lithium iron phosphate, ternary lithium or lithium manganate, etc. The negative electrode plate includes a negative current collector and a negative active material layer, and the negative active material layer is coated on the surface of the negative current collector. The negative current collector includes a negative current collecting portion and a negative protrusion protruding from the negative current collecting portion. The negative current collecting portion is coated with the negative active material layer, at least a portion of the negative protrusion is not coated with the negative active material layer, and the negative protrusion serves as a negative tab. The material of the negative current collector is copper. The negative active material layer includes a negative active material, and the negative active material is carbon or silicon. The material of the separator is polypropylene (PP) or polyethylene (PE).

The top cover assembly 30 in the embodiment of the present disclosure includes a cover 31, a first conductive portion 32 and a second conductive portion 33. The cover 31, the first conductive portion 32 and the second conductive portion 33 are in insulating connection, the first conductive portion 32 is connected to the first tab 21, and the second conductive portion 33 is connected to the second tab 22.

Specifically, the thickness of the first conductive portion 32 and/or the thickness of the second conductive portion 33 are 0.6-1.5 mm. the thickness of the first conductive portion 32 and/or the thickness of the second conductive portion 33 are set according to actual needs.

Compared with the related art, through the cooperative use of the housing 10, the cell 20 and the top cover assembly 30, the cell 20 is arranged in the housing 10, and the top cover assembly 30 covers the opening 11 of the housing 10. The cell 20 is provided with the first tab 21 and the second tab 22. The first tab 21 and the second tab 22 are located on the same end face of the cell 20. The top cover assembly 30 includes the cover 31, the first conductive portion 32 and the second conductive portion, and the cover 31, the first conductive portion 32 and the second conductive portion 33 are in insulating connection. The first conductive portion 32 is connected to the first tab 21, and the second conductive portion 33 is connected to the second tab 22. Through the arrangement of the above structure, the disclosure arranges the first tab 21 and the second tab 22 on the same end face of the cell 20, the first tab 21 is able to be directly connected to the first conductive portion 32, and the second tab 22 is able to be directly connected to the second conductive portion 33 without the need of a connecting piece, so that the utilization rate of the internal space of the battery 100 is effectively improved while the cost is saved, and the energy density of the battery 100 is further improved.

A first through hole 311 and a second through hole 312 are formed in the cover 31 in the embodiment of the present disclosure in the thickness direction thereof. The first conductive portion 32 is arranged in the first through hole 311 and is in insulating sealing connection with the cover 31, and the second conductive portion 33 is arranged in the second through hole 312 and is in insulating sealing connection with the cover 31, so that the first conductive portion 32 and the second conductive portion 33 are effectively installed. Meanwhile, the first tab 21 is connected to the outside through the first conductive portion 32, and the second tab 22 is connected to the outside through the second conductive portion 33.

Specifically, a first insulating seal 40 is arranged between the first through hole 311 and the first conductive portion 32, and a second insulating seal 50 is arranged between the second through hole 312 and the second conductive portion 33. The first insulating seal 40 is matched with the second insulating seal 50, the first insulating seal 40 is arranged between the first through hole 311 and the first conductive portion 32, and the second insulating seal 50 is arranged between the second through hole 312 and the second conductive portion 33, so that the cover 31, the first conductive portion 32 and the second conductive portion 33 are effectively insulated, and the first conductive portion 32, the second conductive portion 33 and the cover 31 are effectively prevented from contacting, causing the short circuit of the battery 100.

Specifically, the shape of the first through hole 311 and the shape of the second through hole 312 are both circular, rectangular or trapezoidal.

In the embodiment of the disclosure, the cross section of the first insulating seal 40 and/or the cross section of the second insulating seal 50 is T-shaped, [symbol] -shaped or [symbol] -shaped. By setting the cross section of the first insulating seal 40 and/or the cross section of the second insulating seal 50 is T-shaped, [symbol] -shaped or [symbol] -shaped, effectively increasing a structural option of the first insulating seal 40 and/or the second insulating seal 50, and is set according to actual needs.

In the embodiment of the present disclosure, a plurality of first nanopores are formed in a surface where the first through hole 311 is connected to the first insulating seal 40, and the first insulating seal 40 is in part embedded into the plurality of first nanopores. And/or a plurality of second nanopores are formed in a surface where the second through hole 312 is connected to the second insulating seal 50, and the second insulating seal 50 is in part embedded into the plurality of second nanopores. Through the arrangement of the above embodiment, thus effectively improving the binding force among the first insulating seal 40, the second insulating seal 50 and the cover 31, ensuring good airtightness at joints of the first insulating seal 40, the second insulating seal 50 and the cover 31, and accordingly improving the airtightness of the battery 100.

Specifically, the first insulating seal 40 is formed between the first through hole 311 and the first conductive portion 32 by means of injection molding or nano injection molding. Similarly, the second insulating seal 50 is formed between the second through hole 312 and the first conductive portion 32 by means of injection molding or nano injection molding.

In the embodiment of the present disclosure, the thickness of the first insulating seal 40 and the thickness of the second insulating seal 50 are both 1-3 mm. The thickness of the first insulating seal 40 and the thickness of the second insulating seal 50 are set according to actual needs.

In the embodiment of the present disclosure, the first conductive portion 32 is made of a same material as the first tab 21, and the second conductive portion 33 is made of a same material as the second tab 22, so as to improve the welding effect between the first conductive portion 32 and the first tab 21 and the welding effect between the second conductive portion 33 and the second tab 22.

In the embodiment of the present disclosure, one of the first conductive portion 32 and the second conductive portion 33 is made of aluminum while the other one of the first conductive portion 32 and the second conductive portion 33 is made of copper or nickel-plated copper. When the first tab 21 is the positive tab and the second tab 22 is the negative tab, the first conductive portion 32 is made of aluminum, and the second conductive portion 33 is made of copper or nickel-plated copper. When the first tab 21 is the negative tab and the second tab 22 is the positive tab, the first conductive portion 32 is made of copper or nickel-plated copper, and the second conductive portion 33 is made of aluminum.

In the embodiment of the present disclosure, the cover 31 is made of a same material as the housing 10. The cover 31 is set to be made of the same material as the housing 10, which facilitates piercing or welding sealing connection between the top cover assembly 30 and the housing 10.

Another embodiment of the present disclosure is a battery module, including a box and a plurality of batteries. The plurality of batteries are sequentially arranged in the box in the thickness direction of the box, and at least one battery is the cylindrical battery in the above embodiment.

Compared with the related art, through cooperative use of the box and the plurality of batteries, the plurality of batteries are sequentially arranged in the box in the thickness direction of the box, and at least one battery is the cylindrical battery in the above embodiment. The utilization rate of the internal space of the battery 100 is high, the energy density of the battery 100 is large, and positive and negative poles of the battery 100 are located on a same side of the battery 100, thus facilitating a design of a busbar inside the box.

In another embodiment of the present disclosure, the plurality of batteries are connected in series, in parallel or in parallel-series. The parallel-series connection means that the plurality of batteries are connected in series and in parallel. The plurality of batteries are directly connected in series, in parallel or in parallel-series, and then a whole of the plurality of batteries is accommodated in the box. Of course, the plurality of batteries also are first connected in series, in parallel or in parallel-series to form the battery module, and then a plurality of battery modules are connected in series, in parallel or in parallel-series to form a whole, and are accommodated in the box. In some embodiments, the plurality of batteries are provided, and the plurality of batteries are first connected in series, in parallel, or in parallel-series to form the battery module. Then a plurality of battery modules are connected in series, in parallel or in parallel-series to form a whole and accommodated in the box.

According to the disclosure and teaching of the above specification, those skilled in the art to which the present disclosure pertains may also change and modify the above implementations. Therefore, the present disclosure is not limited to the above specific implementations, and any obvious improvement, substitution or modification made by those skilled in the art on the basis of the present disclosure shall fall within the protection scope of the present disclosure. In addition, although some specific terms are used in the specification, these terms are only for convenience of description and do not constitute any limitation to the present disclosure.

What is claimed is:

1. A cylindrical battery, comprising:
a housing, provided with an opening;
a cell, arranged in the housing, the cell is provided with a first tab and a second tab with the polarity opposite to that of the first tab, and the first tab and the second tab are both located on a same end face of the cell; and
a top cover assembly, sealing the opening and comprising a cover, a first conductive portion and a second conductive portion, wherein the cover, the first conductive portion and the second conductive portion are in insulating connection, the first conductive portion is connected with the first tab, and the second conductive portion is connected with the second tab.

2. The cylindrical battery according to claim 1, wherein a first through hole and a second through hole are formed in the cover in the thickness direction thereof in a penetrating manner, the first conductive portion is arranged in the first through hole and is in insulating sealing connection with the cover, and the second conductive portion is arranged in the second through hole and is in insulating sealing connection with the cover.

3. The cylindrical battery according to claim 2, wherein a first insulating seal is arranged between the first through hole and the first conductive portion, and a second insulating seal is arranged between the second through hole and the second conductive portion.

4. The cylindrical battery according to claim 3, wherein the cross section of the first insulating seal and/or the cross section of the second insulating seal is T-shaped, [symbol] -shaped or [symbol] -shaped.

5. The cylindrical battery according to claim 4, wherein a plurality of first nanopores are formed in a surface where the first through hole is connected to the first insulating seal, and the first insulating seal is in part embedded into the plurality of first nanopores.

6. The cylindrical battery according to claim 4, wherein
a plurality of second nanopores are formed in a surface where the second through hole is connected to the second insulating seal, and the second insulating seal is in part embedded into the plurality of second nanopores.

7. The cylindrical battery according to claim 4, wherein a plurality of first nanopores are formed in a surface where the first through hole is connected to the first insulating seal, and the first insulating seal is in part embedded into the plurality of first nanopores,
a plurality of second nanopores are formed in a surface where the second through hole is connected to the second insulating seal, and the second insulating seal is in part embedded into the plurality of second nanopores.

8. The cylindrical battery according to claim 3, wherein the thickness of the first insulating seal and the thickness of the second insulating seal are both 1-3 mm.

9. The cylindrical battery according to claim 4, wherein the thickness of the first insulating seal and the thickness of the second insulating seal are both 1-3 mm.

10. The cylindrical battery according to claim 5, wherein the thickness of the first insulating seal and the thickness of the second insulating seal are both 1-3 mm.

11. The cylindrical battery according to claim 1, wherein the first conductive portion is made of a same material as the first tab, and the second conductive portion is made of a same material as the second tab.

12. The cylindrical battery according to claim 1, wherein one of the first conductive portion and the second conductive portion is made of aluminum while the other one of the first conductive portion and the second conductive portion is made of copper or nickel-plated copper.

13. The cylindrical battery according to claim 1, wherein the cover is made of a same material as the housing.

14. A battery module, comprising a box and a plurality of batteries, wherein the plurality of batteries are sequentially arranged in the box in the thickness direction of the box, and at least one of the batteries is the cylindrical battery according to claim 1.

15. The battery module according to claim 14, wherein a first through hole and a second through hole are formed in the cover in the thickness direction thereof in a penetrating manner, the first conductive portion is arranged in the first through hole and is in insulating sealing connection with the cover, and the second conductive portion is arranged in the second through hole and is in insulating sealing connection with the cover.

16. The battery module according to claim 15, wherein a first insulating seal is arranged between the first through hole and the first conductive portion, and a second insulating seal is arranged between the second through hole and the second conductive portion.

17. The battery module according to claim 16, wherein the cross section of the first insulating seal and/or the cross section of the second insulating seal is T-shaped, [symbol] -shaped or [symbol] -shaped.

18. The battery module according to claim 14, wherein the first conductive portion is made of a same material as the first tab, and the second conductive portion is made of a same material as the second tab.

19. The battery module according to claim 14, wherein one of the first conductive portion and the second conductive portion is made of aluminum while the other one of the first conductive portion and the second conductive portion is made of copper or nickel-plated copper.

20. The battery module according to claim 14, wherein the cover is made of a same material as the housing.
